(19) United States
(12) Patent Application Publication
(10) Pub. No.: US 2015/0264867 A1
(43) Pub. Date: Sep. 24, 2015

(54) Plant Cultivation Apparatus

(71) Applicant: Yu-Feng Chuang, Bade City (TW)

(72) Inventor: Yu-Feng Chuang, Bade City (TW)

(21) Appl. No.: 14/222,722

(22) Filed: Mar. 24, 2014

(51) Int. Cl. A01G 9/02

(52) U.S. Cl. CPC A01G 9/02

(57) ABSTRACT

A plant cultivation apparatus includes at least one housing, a lamp holder mounted on an upper end of the housing, a basin mounted on a lower end of the housing and containing soil, a light emitting diode (LED) lamp mounted on the lamp holder, a water pipe connected with the housing to supply water to the soil of the basin, a constant rate timing device connected with the water pipe, an external water source connected with the water pipe, and a high oxygen water generating device connected with the water pipe. Thus, the plant cultivation apparatus can enhance the growth efficiency of the plant by provision of the high oxygen water generating device. In addition, the plant cultivation apparatus has sterilizing and odorizing functions by provision of the ozone generating device.

### BACKGROUND OF THE INVENTION

1. Field of the Invention

The present invention relates to a cultivation apparatus and, more particularly, to a plant cultivation apparatus available for cultivating plants indoors.

2. Description of the Related Art

A conventional indoor plant cultivation apparatus comprises a housing, a lamp holder mounted on the housing, a basin mounted in the housing and containing soil for raising plants, and a lamp mounted on the lamp holder. Thus, the lamp provides a light source to the plants so as to grow the plants. However, the lamp is the only source to cultivate the plants so that the conventional plant cultivation apparatus has a poor growth efficiency for the plants. In addition, the conventional plant cultivation apparatus does not have sterilizing and odorizing functions.

### BRIEF SUMMARY OF THE INVENTION

In accordance with the present invention there is provided a plant cultivation apparatus comprising at least one housing, a lamp holder mounted on an upper end of the housing, a basin mounted on a lower end of the housing and containing soil, a light emitting diode (LED) lamp mounted on the lamp holder, a water pipe connected with the housing to supply water to the soil of the basin, a constant rate timing device connected with the water pipe, an external water source connected with the water pipe, and a high oxygen water generating device connected with the water pipe.

Preferably, the high oxygen water generating device contains high oxygen water having an oxygen content greater than 35 ppm.

Preferably, the plant cultivation apparatus further comprises an ozone generating device connected with the basin. The ozone generating device includes a plurality of air pipes extended through the housing and the basin into the soil.

Preferably, the plant cultivation apparatus further comprises a plurality of far infrared (FIR) ceramic balls mounted in and mixed with the soil of the basin.

Preferably, the plant cultivation apparatus comprises a plurality of housings stacked together.

Preferably, the plant cultivation apparatus further comprises a water dish mounted on a bottom of the basin.

According to the primary advantage of the present invention, the plant cultivation apparatus can enhance the growth efficiency of the plant by provision of the high oxygen water generating device.

According to another advantage of the present invention, the plant cultivation apparatus has sterilizing and odorizing functions by provision of the ozone generating device.

According to a further advantage of the present invention, the plant cultivation apparatus can boost growth of the plant by provision of the far infrared ceramic balls.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front cross-sectional block view of a plant cultivation apparatus in accordance with the preferred embodiment of the present invention.

### DETAILED DESCRIPTION OF THE INVENTION

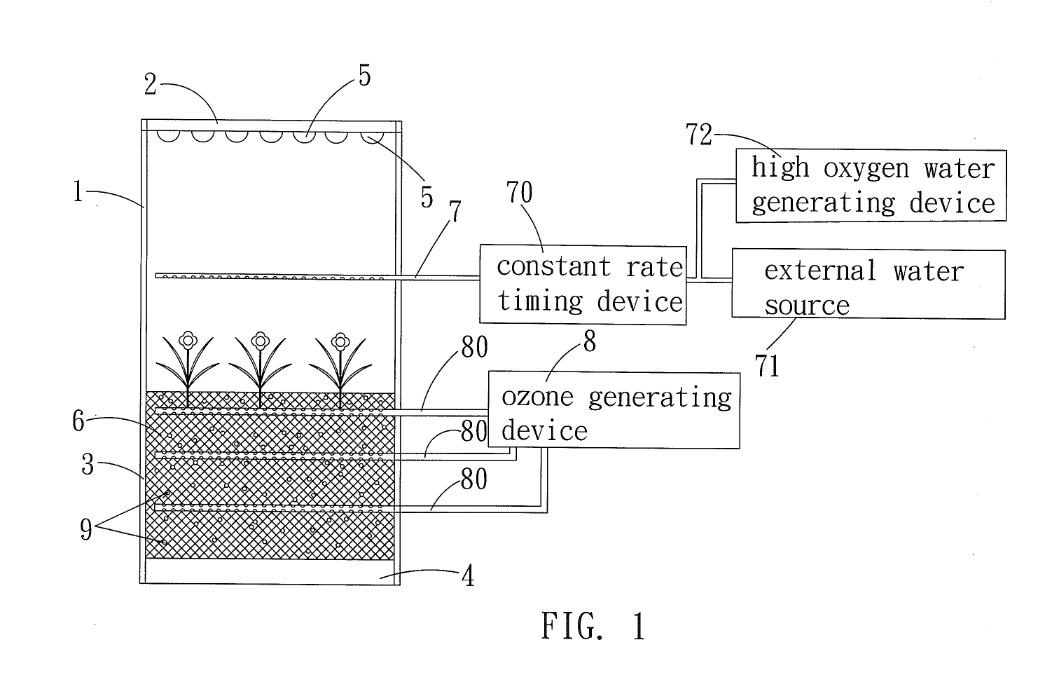

Referring to FIG. 1, a plant cultivation apparatus in accordance with the preferred embodiment of the present invention comprises at least one housing 1, a lamp holder 2 mounted on an upper end of the housing 1, a basin 3 mounted on a lower end of the housing 1 and containing soil 6, a water dish 4 mounted on a bottom of the basin 3, a light emitting diode (LED) lamp 5 mounted on the lamp holder 2, a water pipe 7 connected with the housing 1 to supply water to the soil 6 of the basin 3, a constant rate timing device 70 connected with the water pipe 7, an external water source 71 connected with the water pipe 7, and a high oxygen water generating device 72 connected with the water pipe 7.

The LED lamp 5 includes a light source with different wavelength to fit plants of different kinds and features. The bottom of the basin 3 is provided with a plurality of draining holes (not shown). The water pipe 7 is extended into the housing 1 and is located between the LED lamp 5 and the basin 3. The constant rate timing device 70 is located between the water pipe 7 and the external water source 71. The external water source 71 supplies water to the water pipe 7 at a preset time and a preset water flow rate by operation of the constant rate timing device 70. The high oxygen water generating device 72 is located between the constant rate timing device 70 and the external water source 71. The high oxygen water generating device 72 contains high oxygen water which is supplied to the soil 6 of the basin 3 so as to cultivate a plant placed on the soil 6 of the basin 3. The high oxygen water specially suitable for being absorbed by the plant to enhance the growth efficiency of the plant. In the preferred embodiment of the present invention, the high oxygen water of the high oxygen water generating device 72 has an oxygen content greater than 35 ppm.

The plant cultivation apparatus further comprises an ozone (O₃) generating device 8 connected with the basin 3, and a plurality of far infrared (FIR) ceramic balls 9 mounted in and mixed with the soil 6 of the basin 3. The ozone generating device 8 includes a plurality of air pipes 80 extended through the housing 1 and the basin 3 into the soil 6. The ozone generating device 8 provides ozone to the soil 6 of the basin 3 to achieve sterilizing and odorizing purposes. The far infrared ceramic balls 9 emit far infrared rays (with wavelength of 8,000 to 14,000 nm) which are projected onto the embryo of the plant in the soil 6 of the basin 3 to activate the activity of yeast so as to accelerate budding of the plant.

In another preferred embodiment of the present invention, the plant cultivation apparatus comprises a plurality of housings 1 stacked together to save the space of storage.

Accordingly, the plant cultivation apparatus can enhance the growth efficiency of the plant by provision of the high oxygen water generating device 72. In addition, the plant cultivation apparatus has sterilizing and odorizing functions by provision of the ozone generating device 8. Further, the plant cultivation apparatus can boost growth of the plant by provision of the far infrared ceramic balls 9.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A plant cultivation apparatus comprising:
at least one housing;
a lamp holder mounted on an upper end of the housing;
a basin mounted on a lower end of the housing and containing soil;
a light emitting diode (LED) lamp mounted on the lamp holder;
a water pipe connected with the housing to supply water to the soil of the basin;
a constant rate timing device connected with the water pipe;
an external water source connected with the water pipe; and
a high oxygen water generating device connected with the water pipe.

2. The plant cultivation apparatus of claim 1, wherein the high oxygen water generating device contains high oxygen water having an oxygen content greater than 35 ppm.

3. The plant cultivation apparatus of claim 1, wherein:
the plant cultivation apparatus further comprises an ozone generating device connected with the basin; and
the ozone generating device includes a plurality of air pipes extended through the housing and the basin into the soil.

4. The plant cultivation apparatus of claim 1, further comprising:
a plurality of far infrared (FIR) ceramic balls mounted in and mixed with the soil of the basin.

5. The plant cultivation apparatus of claim 1, wherein the plant cultivation apparatus comprises a plurality of housings stacked together.

6. The plant cultivation apparatus of claim 1, further comprising:
a water dish mounted on a bottom of the basin.
